(19) United States
(12) Patent Application Publication
(10) Pub. No.: US 2010/0027474 A1
(43) Pub. Date: Feb. 4, 2010

(54) Packet Communication Device

(75) Inventors: Jun Hirano, Kanagawa (JP); Chan Wah Ng, Singapore (SG); Tien Ming Benjamin Koh, Singapore (SG); Pek Yew Tan, Singapore (SG)

Correspondence Address: Dickinson Wright PLLC;James E. Ledbetter, Esq., International Square, 1875 Eye Street, N.W., Suite 1200, Washington, DC, 20006, US

(73) Assignee: Panasonic Corporation, Osaka (JP)

(21) Appl. No.: 12/531,469

(22) PCT Filed: Mar. 13, 2008
(86) PCT No.: PCT/JP2008/000563

§ 371 Date: Sep. 15, 2009

(30) Foreign Application Priority Data
Mar. 16, 2007 (JP) 2007-069481

(51) Int. Cl. H04W 40/00

(52) U.S. Cl. 370/328

(57) ABSTRACT

A technique is disclosed, according to which a mobile node detects generation of redundant route optimization messages to an address owned by a node, which already recognizes and comprehends binding with a care-of address and a home address of the mobile node. According to this technique, a CN (correspondent node) 60 uses two addresses 134 and 136. When MN 50 executes route optimization procedure with the address 134 and transmits a BU (binding update) message 210 to register related information of a care-of address and a home address of its own, CN sends back information of another address 136 by putting it in a BA (binding acknowledgment) message 220. MN recognizes and comprehends that CN owns another address 136, and when route optimized communication with another address 136 is started, MN transmits a data packet 230 without performing return routability procedure or without transmitting the BU message.

### FIELD OF THE INVENTION

The present invention relates to a packet communication device in a packet-exchange type data communication network such as IP (Internet Protocol) network. In particular, the invention relates to a packet communication device provided with a protocol, which has mobility management function such as the Mobile IPv6 (Internet Protocol version 6) and is capable to carry out route optimization with a correspondent node when packet communication is performed.

### BACKGROUND ART

At present, a multiple of devices are performing communication with each other by using Internet protocol. For the purpose of providing mobility support for mobile devices, mobility support in IPv6 (see the Non-Patent Document 1 as given below) or network mobility support (see the Non-Patent Document 2 as given below) are defined by IETF (Internet Engineering Task Force). In the mobile IP, each mobile node has a constant home domain. When the mobile node is connected to its own home network, a primary global address known as a home address (HoA) is assigned to the mobile node.

On the other hand, when the mobile node is separated away from the home network, i.e. when it is connected to other foreign network, a temporary global address known as a care-of address (CoA) is normally assigned to the mobile node. The concept of the mobility support is such that, even when the mobile node is connected to the other foreign network, the mobile node can be reached by using its own home address.

According to the Non-Patent Document 1, this concept is practically carried out by introducing an entity known as a home agent (HA) to the home network. The mobile node registers a care-of address to the home agent by using a message known as a binding update (BU) message. As a result, the home agent can generate a binding between the home address and the care-of address of the mobile node. The home agent intercepts the message destined to the home address of the mobile node, and it fulfills the function to transfer the packet to the care-of address of the mobile node by encapsulating the packet (i.e. by turning a packet to a payload of a new packet; also known as packet tunneling).

When the concept of the mobility support for each host is extended to the mobility support for network of the node, even in case the mobile network is connected to any connection point with respect to Internet, it is desirable to have a mechanism, by which it can be reached to a node within the mobile network by using a primary global address.

It is described in the Non-Patent Document 2 that, when a BU (binding update) message is transmitted to a home agent, a mobile router indicates a network prefix used by the node within the mobile network. For instance, by putting a specific option called network prefix option in the BU message, the mobile router can designate a network prefix. As a result, the home agent builds up a routing table based on the prefix and the packet to be transmitted to a destination address having this network prefix can be transferred to the care-of address of the mobile router.

With the improvement and the progress of the access technique, each device has a plurality of network access functions. By connecting different connection points at the same time, it is possible to connect to a global communication network (e.g. Internet) via a plurality of connection points. Therefore, a mobile node (i.e. a host to start the Mobile IPv6, or a router to start the network mobility support) has more chances to perform communication with a correspondent node, which has a plurality of addresses. Now, referring to FIG. 1A, description will be given on an example of network connection including a node with a plurality of addresses.

FIG. 1A shows an example of a network arrangement in the prior art. In FIG. 1A, various types of edge networks are shown, which are connected to a global communication network (e.g. Internet).

In a home network 11, a home agent (HA) 111 can access a global communication network 10 via two Internet service providers ISP 20 and ISP 22. These two ISP 20 and ISP 22 are independent from each other, and two different prefixes 30 and 32 are provided in the home network 11. As a result, the home agent (HA) 111 can have two different addresses (i.e. an address with the prefix 30, and an address with the prefix 32).

Also, an example of a case is shown by CN (correspondent node) 60 where the node can have a plurality of addresses. This CN 60 is present on a subnet where there are two egress routers ER 24 and ER 26. These two egress routers are: ER 24 for notifying the prefix 34, and ER 26 for notifying the prefix 36. Thus, the correspondent node (CN) 60 can have two different addresses (i.e. an address with the prefix 34, and an address with the prefix 36).

As an example of a node with a plurality of addresses, there is a case where a node has two different interfaces connected to different subnets respectively. In FIG. 1A, such case is shown by CN 62. This CN 62 has a wired Ethernet (registered trademark) interface and a wireless local area network (WLAN) interface, and these interfaces are connected to different subnets of an office network 14 respectively. This means that the correspondent node (CN) 62 has two different addresses (an address with a prefix 38 and another address with a prefix 40).

Also, there is a case where a node, which can have a plurality of addresses, acts as a proxy of a plurality of nodes. An example of such case is shown by a proxy home agent (pHA) 116. This pHA 116 fulfills the functions as a proxy home agent in an overlay network of the home agents, which are HA 111, HA 112, and pHA 116, for instance.

In order to accomplish efficient routing, when a mobile node (MN) 50, which has HA 111 as its home agent, moves to an access network 16 where pHA 116 is present, pHA 116 fulfills the function as a proxy of HA 111 by processing binding update transmitted from MN 50 on behalf of HA 111. Similarly, pHA 116 acts as a proxy home agent of HA 112 for the other mobile node belonging to the home network 12. In this way, pHA 116 is regarded as having a plurality of addresses (i.e. addresses of HA 111 and HA 112).

When the mobile node (e.g. MN 50) is performing communication with a node (e.g. CN 60), which has a plurality of addresses, excessive signaling may be transmitted from MN 50 as shown in the sequence chart of FIG. 1B. In FIG. 1B, MN 50 exchanges initial setting messages for route optimization with the address 134 of CN 60 with the prefix 34. For instance, these messages are: a home test init (HoTI) message 140, a home test (HoT) message 142, a care-of test init (CoTI) message 144, care-of test (CoT) message 146, etc.

Finally, a binding update (BU) message 148 is transmitted from MN 50, and a route optimized path is established. Using the address 134, CN 60 transmits a binding acknowledgment (BA) message 150 as a reply.

It is supposed that an arbitrary application of MN 50 has recognized thereafter the presence of a node (CN 60), which has the address 136 with the prefix 36. In this case, if MN 50 does not know that CN 60 also has the address 136, MN 50 starts a processing to carry out another route optimization. In this processing to carry out the route optimization relating to this address, similarly to the case of the route optimization performed with respect to the address 134, messages of HoTI 160, HoT 162, CoTI 164, CoT 166, BU 168, and BA 170 are exchanged.

However, when it is aimed that CN 60 would be able to recognize the current care-of address of MN 50, CN 60 has already recognized the current care-of address of MN 50 by setting of the first messages 140-150 relating to the address 134, and the setting of the messages 160-170 relating to the address 136 is apparently redundant.

For instance, the Non-Patent Document 3 discloses a protocol currently discussed at IETF (a protocol called Shim6 protocol). By Shim6, an end node can fulfill multi-homing function, and as a result, the nodes performing communication with each other can recognize reachable address.

Also, it is disclosed in the Non-Patent Document 4 as given below that a stream control transmission protocol (SCTP) is disclosed instead of a transmission control protocol (TCP) widely in use. This stream control transmission protocol has multi-homing function, and the endpoint of the SCTP session can have a plurality of addresses.

Further, in the Patent Document 1 as given below, a method is disclosed, according to which a mobile node transmits a condensed binding update message to a home agent, and the home agent transmits the binding update to each of a plurality of different correspondent nodes as included in the condensed binding update message. As a result, the mobile node can give notification to a plurality of correspondent nodes by a single binding update message.

Similarly, the Patent Document 2 as given below discloses a method of home agent synchronization, by which a certain home agent transmits a binding update message to another home agent. In this technique also, the mobile node can give notification to a plurality of home agents by merely transmitting a single binding update message.

Further, a method using a system by a correspondent router is disclosed in the Patent Document 3 as given below. According to this technique disclosed in the Patent Document 3, a correspondent router can terminate route optimization as a representative of several correspondent nodes (normally, the entire network of the correspondent nodes). In this case, the mobile node can have benefit from the route optimization using addresses of the entire network of correspondent nodes by merely transmitting a set of route optimization signaling messages to the correspondent nodes.
[Patent Document 1] U.S. Patent Application Publication No. 2005/0044362.
[Patent Document 2] International Application Publication No. WO 06/068439.
[Patent Document 3] International Application Publication No. WO 06/064960.
[Non-Patent Document 1] Johnson, D. B., Perkins, C. E., and Arkko, J.: “Mobility Support in IPv6”; Internet Engineering Task Force Request for Comments 3775; June 2004.
[Non-Patent Document 2] Devarapalli, V, et al.: “NEMO Basic Support Protocol”; Internet Engineering Task Force Request for Comments 3963; January 2005.
[Non-Patent Document 3] Nordmark, E., et al.: “Level 3 Multi-homing Shim Protocol”; Internet Draft: draft-ietf-shim6-proto-05.text; work-in-progress, May 2006.
[Non-Patent Document 4] Stewart, R., et al.: “Stream Control Transmission Protocol”; Internet Engineering Task Force Request for Comments 2960; October 2000.

However, both the Shim6 protocol disclosed in the Non-Patent Document 3 and the SCTP disclosed in the Non-Patent Document 4 are designed to be executed in an upper layer of a routing layer of protocol stack of the node. Therefore, the routing layer with mobility management function cannot recognize that a plurality of addresses are owned by the same node.

Specifically, the problem as described above (i.e. a problem that excessive route optimization signaling messages are transmitted to different addresses of the same node) is not solved, and the use of the Shim6 protocol or the SCTP would be insufficient to solve the problem.

Also, according to the technique disclosed in the Patent Documents 1 and 2, a mobile node can give notification to a plurality of nodes by using a single binding update message, while a different other message is transmitted. That is, according to the technique disclosed in the Patent Documents 1 and 2, the consumption of bandwidth caused by excessive signaling can be reduced, while the problem of generation of excessive signaling cannot be solved.

Further, according to the technique disclosed in the Patent Document 3, there are problems in that it is necessary to build up an infrastructure and to execute the procedure to establish confident relationship between the correspondent router and the mobile node.

### DISCLOSURE OF THE INVENTION

To solve the above problems, it is an object of the present invention to reduce the exchange of excessive messages by detecting generation of redundant route optimization message to the addresses owned by a node, which already recognizes binding of a care-of address and a home address of a mobile node.

To attain the above object, the present invention provides a packet communication device, which comprises packet communication means for performing communication via a network;

binding update processing means for carrying out return routability procedure and binding update processing to execute route optimization with a specific address;

link address acquiring means for acquiring another address usable by a communication device using said specific address;

link address storage means for associating said specific address with said another address of said communication device acquired by said link address acquiring means and storing said addresses;

link address confirming means for confirming whether or not said new address concurs with said another address of said communication device based on information stored in said link address storage means, when performing route optimization with a new address; and

route optimization communication control means for controlling starting of route optimized communication with said new address without carrying out said return routability procedure and said binding update processing relating to said new address when it is confirmed that said new address concurs with said another address of said communication device.

By the arrangement as described above, a mobile node can detect generation of redundant route optimization message to the addresses owned by a node, which already recognizes binding of care-of address and home address of the mobile node.

Further, in addition to the arrangement as given above, the present invention provides the packet communication device as described above, wherein said link address acquiring means acquires a list of said other addresses usable by said communication device from a message received from said communication device.

By the arrangement as given above, it is possible to receive notification of a plurality of addresses used by the communication device from a communication device, which is the correspondent.

Also, in addition to the arrangement as given above, the present invention provides the packet communication device as described above, wherein said message is a binding acknowledgment message, which is a reply to a binding update message related to said specific address.

By the arrangement as given above, it is possible to acquire a list of a plurality of addresses used by the communication device from the binding acknowledgement message received from the communication device, which is the correspondent.

Further, in addition to the arrangement as given above, the present invention provides the packet communication device as described above, wherein said message is a HoT message or a CoT message of said return routability procedure to be executed for performing route optimized communication with said specific address.

By the arrangement as given above, it is possible to acquire a list of a plurality of addresses used by the communication device from the binding acknowledgement message received from the communication device, which is the correspondent.

Also, in addition to the arrangement as given above, the present invention provides the packet communication device as described above, wherein said binding update processing means is so designed that a binding update message relating to said specific address is transmitted to said another address of said communication device as acquired by said link address acquiring means.

By the arrangement as given above, it is possible to verify whether a plurality of addresses notified from the correspondent communication device is valid or not from the transmission of the binding update message.

Further, in addition to the arrangement as given above, the present invention provides the packet communication device as described above, wherein there is provided address verifying means for verifying whether said another address of said communication device acquired by said link address acquiring means is a valid address or not.

By the arrangement as given above, it is possible to verify whether a plurality of addresses notified from the correspondent communication device are valid or not.

Also, in addition to the arrangement as given above, the present invention provides the packet communication device as described above, wherein said address verifying means transmits a message for verification to said another address and confirms whether said another address is a valid address or not based on a reply message.

By the arrangement as given above, it is possible to verify the validity of a plurality of addresses, which may be owned by the communication device, and this contributes to the improvement of security.

Further, in addition to the arrangement as given above, the present invention provides the packet communication device as described above, wherein said link address storage means is placed under management at a layer for routing processing of the packet, said link address acquiring means belongs to an upper layer higher than a layer where routing processing of said packet is performed, and said link address acquiring means is provided with a layer-to-layer interface capable to directly carry out writing of information to said link address storage means.

By the arrangement as given above, a list of a plurality of addresses of the communication device acquired by Shim6 protocol and STCP is notified to the routing layer with mobility management functions, and it is possible to recognize at the routing layer that a plurality of addresses are owned by the same communication device.

Also, in addition to the arrangement as given above, the present invention provides the packet communication device as described above, wherein it is so designed that said link address acquiring means requests notification of another address usable by said communication device to said communication device.

By the arrangement as given above, it is possible to notify other addresses usable by the correspondent communication device only to the packet communication device, which requested the notification of the addresses.

To attain the above object as described above, the present invention provides a packet communication device, which comprises:

packet communication means for performing communication via a network;

a plurality of addresses managing means for managing a plurality of addresses to be used on communication in said packet communication means; and

address notifying means for notifying a plurality of addresses under management of said plurality of addresses managing means by using a message to be sent to said mobile node in return routability procedure and binding update processing to be executed for performing route optimized communication with a mobile node.

By the arrangement as given above, the mobile node can detect generation of redundant route optimization message to the addresses owned by the node, which already recognizes binding of care-of address and home address of the mobile node.

Further, in addition to the arrangement as given above, the present invention provides the packet communication device as described above, wherein, when a binding update message for performing route optimization with one of a plurality of addresses under management of said plurality of addresses managing means is received from said mobile node, an address list where at least the remaining addresses other than said one address from said plurality of addresses are listed is put in a binding acknowledgment message as a reply to said binding update message.

By the arrangement as given above, when a node using a plurality of addresses receives a binding update message from a mobile node, the node can reply by putting a list of a plurality of addresses owned by itself in a binding acknowledgment message.

Also, in addition to the arrangement as given above, the present invention provides the packet communication device as described above, wherein, when a CoTI message or a HoTI message for performing route optimization with one of a plurality of addresses under management of said plurality of addresses managing means is received from said mobile node, an address list where at least the remaining addresses other than said one address from said plurality of addresses are listed is sent back by putting in a CoT message, which is a reply to said CoTI message, or in a HoT message, which is a reply to said HoTI message.

By the arrangement as given above, when a node using a plurality of addresses receives a CoTI message or a HoTI message from a mobile node, it is possible to reply by putting a list of a plurality of addresses owned by itself in a CoT message or a HoT message.

Further, in addition to the arrangement as given above, the present invention provides the packet communication device as described above, wherein, when a notification request of a plurality of addresses under management of said plurality of addresses managing means, said address notifying means notifies a plurality of addresses under management by said plurality of addresses managing means.

By the arrangement as given above, a list of usable addresses can be notified only to the mobile node, which requests the notification of the addresses.

The present invention has the arrangement as described above. A mobile node detects generation of redundant route optimization message to the addresses by a node, which already recognizes binding of care-of address and home address of a mobile node, and effects can be provided to reduce the exchange of excessive messages.

### BRIEF DESCRIPTION OF THE DRAWINGS

FIG. 1A is a schematical drawing to show an example of a network arrangement in the prior art;

FIG. 1B is a sequence chart to show an example of a message exchange to be performed between a mobile node and a node with a plurality of addresses in the prior art;

FIG. 2A is a sequence chart to show an example of a message exchange to be performed between a mobile node and a node with a plurality of addresses in an embodiment of the present invention;

FIG. 2B is a sequence chart to show an example of processing when the mobile node verifies a list of addresses in addition to message exchange to be performed between a mobile node and a node with a plurality of addresses,

FIG. 2C is a sequence chart to show another example of processing when the mobile node verifies a list of addresses in addition to message exchange to be performed between a mobile node and a node with a plurality of addresses;

FIG. 3 is a drawing to show an example of a structure of a binding acknowledgement message in the embodiment of the invention;

FIG. 4 is a drawing to show an example of a functional architecture of a mobile node in the embodiment of the invention;

FIG. 5 is a flowchart to show an example of an algorithm to be executed when the mobile node in the embodiment of the invention processes a received BA message;

FIG. 6 is a flow chart to show an example of an algorithm when the mobile node of the embodiment of the invention determines a packet forwarding method based on a destination address; and

FIG. 7 is a schematical drawing to show an example of a case where a group of nodes is present in the embodiment of the invention.

### BEST MODE FOR CARRYING OUT THE INVENTION

Description will be given below on embodiments of the invention by referring to the attached drawings. According to the invention, a node, which is performing communication with a mobile node, can notify a list of addresses (hereinafter referred as “linked address list”) linked to the mobile node. By this operation, when the mobile node notifies the current binding of its own home address and care-of address to an owner of a certain address, the binding of the mobile node can be recognized at another address as listed in the linked address list including that address. Therefore, the mobile node has no need to transmit a plurality of binding update messages (and further, a packet related to return routability) to the owner of each of the addresses.

In the linked address list, a plurality of addresses owned by a certain node (or, each of a plurality nodes belonging to a certain group) are listed, and from the listing of this linked address list and from the source address of a message to notify the linked address list, it will be found that a plurality of addresses belong to the same node. Also, the owner of the addresses listed in the linked address list is preferably a single entity, while it may also be different entities.

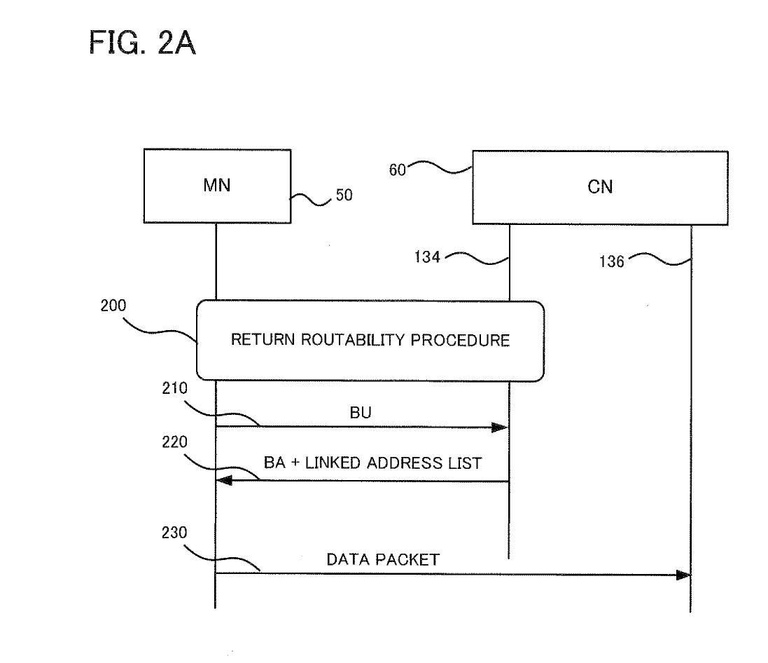

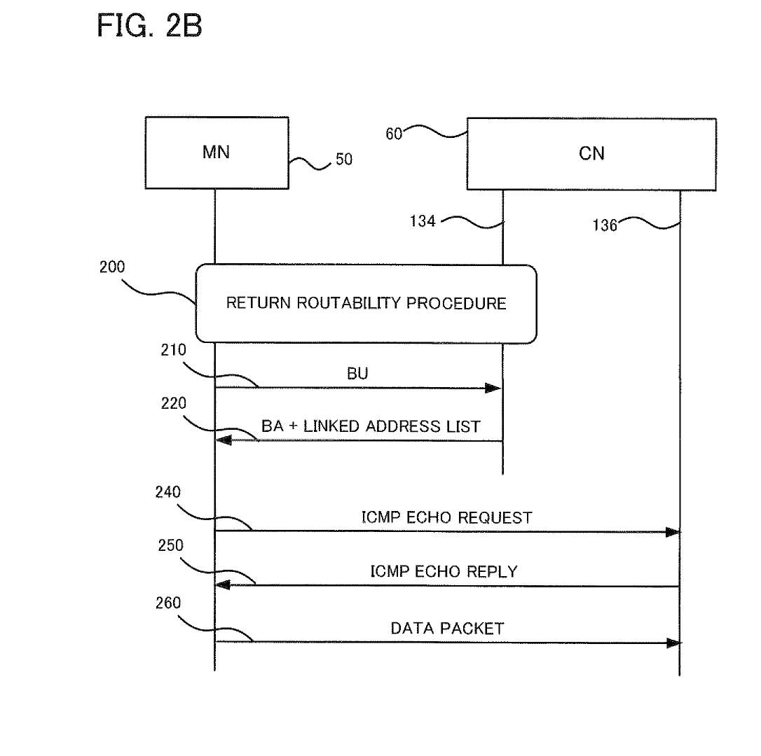

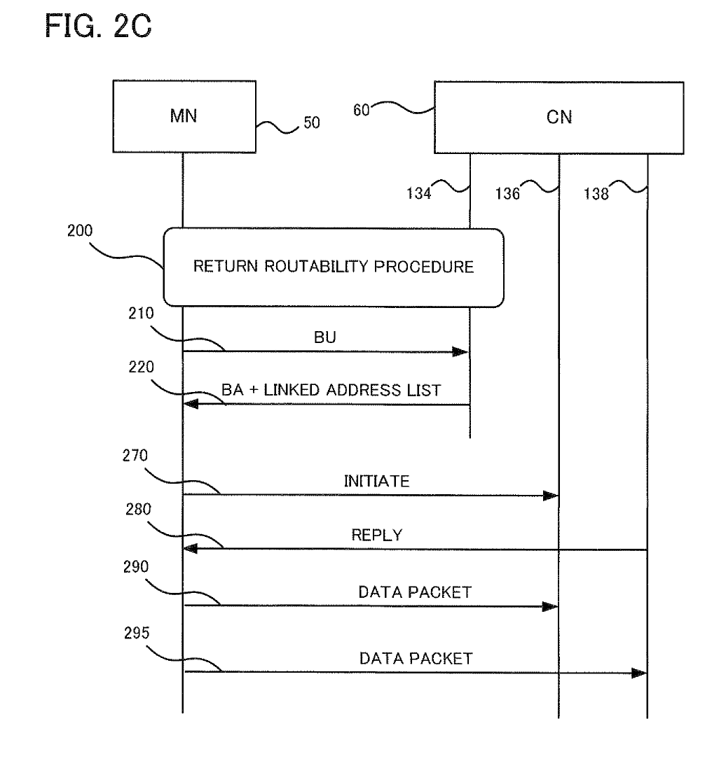

Referring to FIG. 2A, description will be given on an example of operation in an embodiment of the invention. FIG. 2A shows a sequence chart of a message relating to communication between a mobile node (MN) 50 and a correspondent node (CN) 60. It is supposed here that CN 60 has two addresses 134 and 136.

By an arbitrary application as provided on MN 50, communication is performed with CN 60, which has addresses 134 and 136. A mobility layer (e.g. mobile IPv6) of MN 50 is going to start route optimization between the two addresses 134 and 136. At this moment, MN 50 has not recognized yet that the addresses 134 and 136 are owned by the same CN 60.

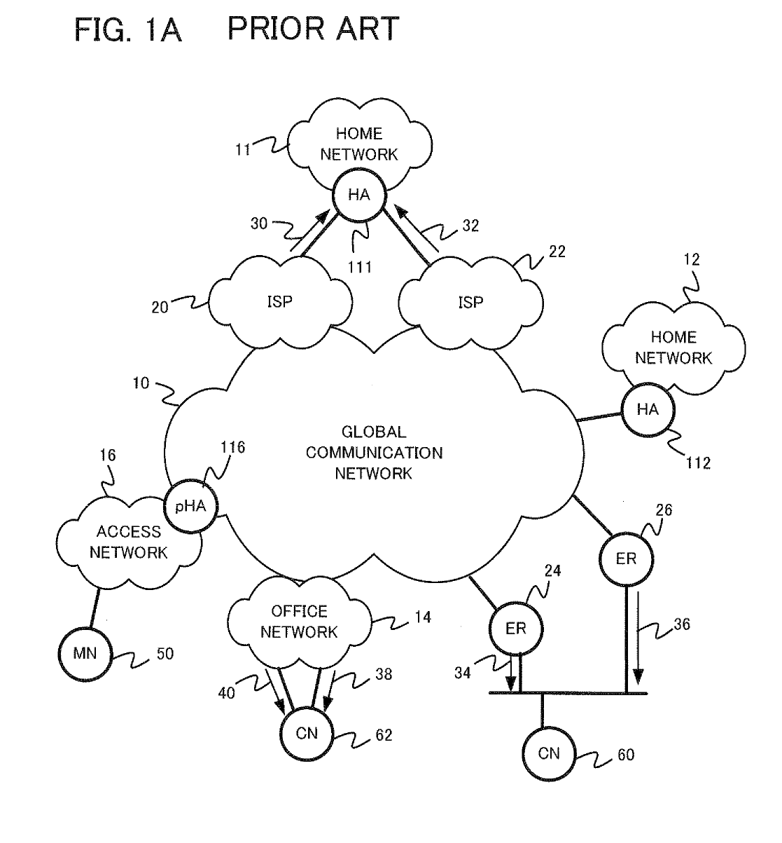

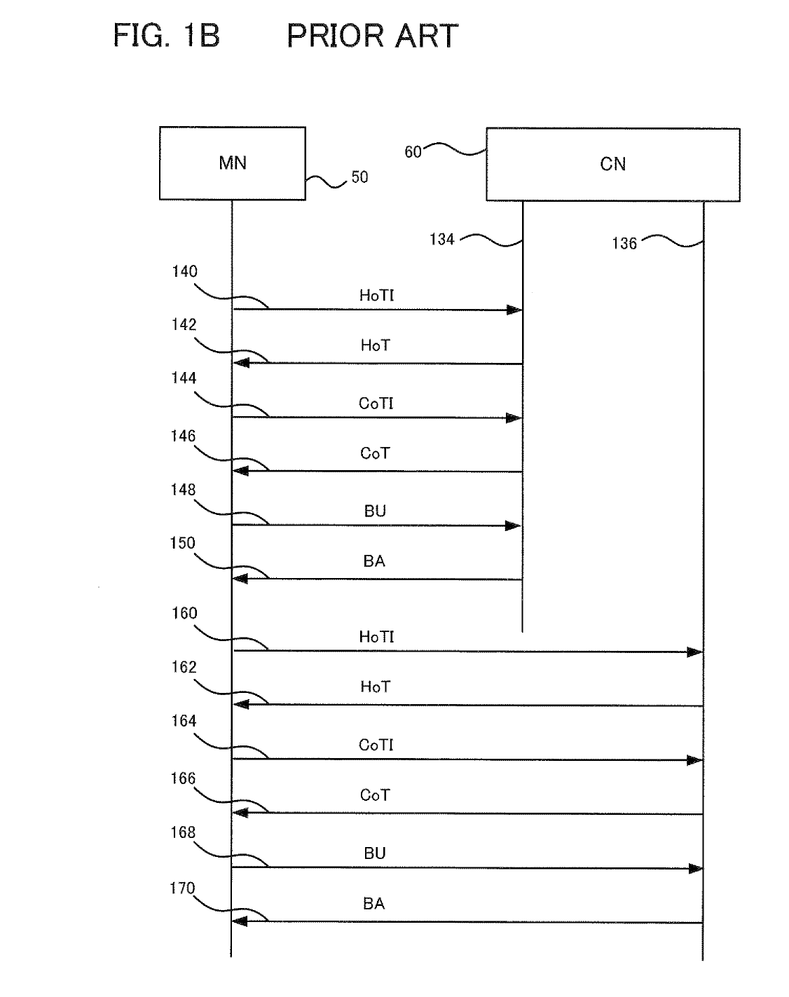

A return routability procedure 200 is initiated with regard to the address 134 of CN 60. In this return routability procedure 200, messages of HoTI, HoT, CoTI and CoT are exchanged between MN 50 and CN 60 (This matches the exchange of messages 140-146 in FIG. 1B). For instance, initial setting processing of route optimization associated with the message exchange other than the above (such as Internet Key Exchange (IKE)) may be simultaneously performed. The present invention is not specifically limited to a method of route optimization, and any arbitrary route optimization establishing processing may be used in the invention.

After the return routability procedure 200, MN 50 can transmit a BU message 210 to the address 134 of CN 60. CN 60 verifies that the received BU message 210 is valid and authentic, and it replies with a BA message (BA+linked address list) 220. In the embodiment of the present invention, any address owned by CN 60 (e.g. the address 136) is included in the BA message 220 as the linked address list.

In this linked address list, an address is included, to which binding information can be notified to an owner of other address when MN 50 transmits a binding information to a certain address (e.g. the address 134) of CN 60. Specifically, when MN 50 transmits a binding information to any arbitrary address listed in the linked address list, it is so processed that binding information is also transmitted to the other addresses included in the linked address list. As a result, there is no need to transmit a separate binding update message by performing return routability procedure to each of these addresses when a plurality of addresses are listed in the linked address list.

In this case, at least the address 136 of CN 60 is included in the linked address list where the source address is contained in the BA message 220, which has the address 134 as the source address, while both of the address 134 and the address 136 may be included in the linked address list. As a result, when MN 50 is going to transmit data to the address 136 of CN 60, there is no need to perform the return routability procedure to the address 136, and the data can be directly transmitted to the address 136 as a data packet 230.

In the operation as described above, it is assumed that MN 50 recognizes that the information transmitted from CN 60 is authentic without verifying. However, if security is taken into account, it is necessary to verify the received information and to confirm that the information is reliable. In this case, the mobile node verifies the validity of information before using the received information. Now, referring to the sequence chart of the message as shown in FIG. 2B, description will be given on the processing to verify the received information.

In FIG. 2B, the processing up to the receiving of the linked address list as included in BA (binding acknowledgment) message 220 by MN 50 is the same as shown in FIG. 2A. Before transmitting the data to the addresses listed on the linked address list, MN 50 decides that the processing to verify these addresses should be performed by using a route optimization mechanism.

For instance, MN 50 can perform verification processing to verify the address by transmitting an echo request message 240 of Internet Control and Message Protocol (ICMP) to the address 136 (the address listed in the linked address list) by using the route optimization mechanism.

In case the address included in the linked address list is valid, an adequate reply is sent back upon receipt of the ICMP echo request message 240 because the owner of the address 136 is the same as the owner of the address 134 and has already recognized the binding information of MN 50. On the other hand, in case the owner of the address 136 has not yet recognized the binding of MN 50, an error message is sent back or no reply is sent.

In FIG. 2B, CN 60 has the address 136 and has already recognized binding information of MN 50. Accordingly, the ICMP echo request message 240 is accepted and processed, and an ICMP echo reply message 250 is sent back to MN 50. Therefore, when the ICMP echo reply message 250 is received, MN 50 successfully verifies the address 136.

By the operation as given above, when MN 50 wants to transmit data to the address 136 of CN 60, it is possible to directly transmit the data to the address 136 as a data packet 260 after verifying the validity of the address 136, and there is no need to carry out the return routability procedure in advance on the address 136.

Here, the address is verified by using ICMP echo request/reply message, while other verifying method may be adopted. For instance, a specific mobility message may be used instead of the ICMP echo request/reply message. As another example, MN 50 can transmit another binding update message to the address (address 136) of CN 60 and CN 60 may reply with a binding acknowledgment message. In this case, a value calculated by using the address (address 136) of CN 60 is used as an authenticator value to be put in the binding update message.

In general, a message to start verification processing (verification start message) is transmitted from MN 50 to an address for verification (address 136) of CN 60. To this message, a verification reply message is sent from CN 60. The verification start message is directly transmitted from the care-of address of MN 50. Also, a home address option is included in the verification start message. That is, the verification start message is transmitted via the route optimization mechanism as if the binding update has been already sent to the address 136 of CN 60. In case the owner of the address 136 does not know current binding of MN 50, this verification start message is abandoned.

Similarly, a verification reply message with a routing header where the home address of MN 50 is given is directly transmitted to the care-of address of MN 50 with respect to the verification reply message. As a result, the fact that the transmitter of the verification reply message (i.e. the owner of the address 136) has already recognized the binding between the care-of address and the home address of MN 50 is indicated to MN 50.

Further, with regard to the message to be used for verification of the address, any arbitrary change of extension may be conducted on the message to be used for verification of the address. For instance, by using a mobility management key as obtained by return routability procedure between MN 50 and the address 134 of CN 60, a checksum of the verification start/reply messages can be generated by encryption. This makes it possible to certify that the owner of the address 136 recognizes the mobility management key between MN 50 and CN 60.

Further, in case CN 60 has a plurality of addresses (three global addresses 134, 136 and 138), it is possible to optimize the verification messages (verification start message/verification reply message). In the optimization in this case, MN 50 transmits a verification start message to one of the addresses (e.g. the address 136) of CN 60, and CN 60 replies by a verification reply message from another address (e.g. the address 138). As a result, by a set of the verification start message and the verification reply message, it is possible to verify two addresses of CN 60. By referring to the sequence chart of the messages as shown in FIG. 2C, description will be given below on this verification processing.

In FIG. 2C, the processing up to the receiving of the linked address list as included in the BA (Binding Acknowledgment message 220 by MN 50 is the same as the processing shown in FIG. 2A. Before transmitting the data to the address given in the linked address list, MN 50 decides that the processing to verify these addresses should be performed by the route optimization mechanism.

Here, MN 50 transmits a verification start message 270 to one of the addresses of CN 60 (e.g. the address 136) by using the route optimization mechanism (i.e. the care-of address of MN 50 is set up as source address of the verification start message 270, and home address destination option with the home address of MN 50 is included in the verification start message 270).

Further, in the verification start message 270, MN 50 specifies that CN 60 should reply to the verification start message 270 via the address 138 of CN 60. If the owner of the address 136 and the address 138 really recognizes the binding of MN 50, upon receipt of this verification start message 270, an adequate verification reply message 280 can be sent back via the address 138. The verification reply message 280 may be sent back via the optimized route. That is, the care-of address of MN 50 is set up at the destination address of the verification reply message 280, and it may be so designed that a type 2 routing header to indicate the home address of MN 50 is included in the verification reply message 280.

When the verification reply message 280 is received, this means that MN 50 has successfully verified both of the address 136 and the address 138. As a result, when MN 50 wants to transmit the data to the address 136 of CN 60, there is no need to perform the return routability procedure to the address 136, and the data can be directly transmitted to the address 138 as a data packet 290. Similarly, when it is wanted to transmit the data to the address 138 of CN 60, there is no need to carry out the return routability procedure to the address 138, and the data can be directly transmitted to the address 138 as a data packet 295.

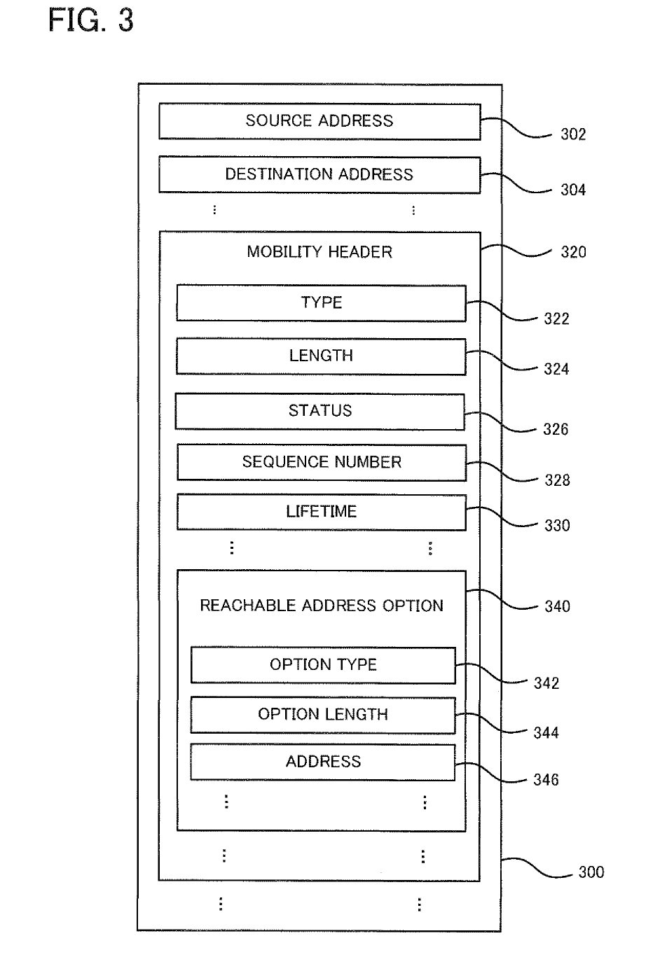

FIG. 3 shows an example of a preferred format 300 of the binding acknowledgment message. Referring to FIG. 3, description will be given on a BA message where the linked address list can be put in.

The address of a transmitter is included in a source address field 302, and an address of a receiver is included in a destination address field 304. In case a BA message is used for transmission of the linked address list, a mobility header 320 is contained in the format 300 of the BA message.

A type field 322 represents that this message is a BA message, and a length field 324 indicates size of a mobility header 320. Also, a status field 326 to indicate status of binding, a sequence number field 328 including the same sequence number as the corresponding binding update message, and a lifetime field 330 to indicate effective period of the received binding are included in the BA message. Also, fields 322-330 of the mobility header 320 are standard fields as defined by the Mobile IPv6 or by network mobility support.

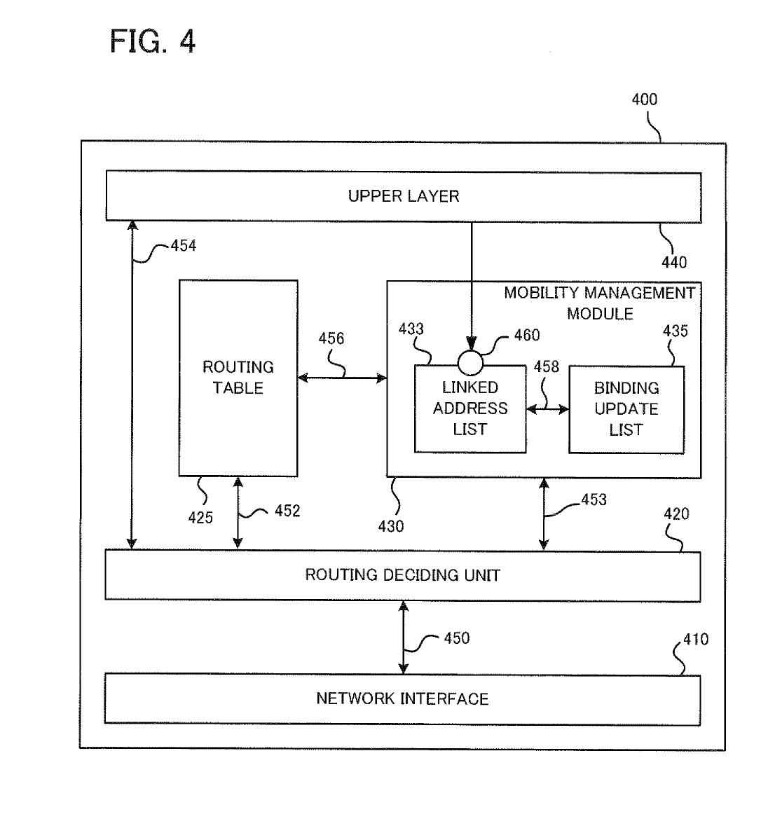

In the present invention, the linked address list is put in the BA message as a new option, for instance. One example of such option is a reachable address option 340 as shown in FIG. 4. This reachable address option 340 is a mobility header option to be put in the mobility header 320, and an option type field 342, an optional length field 344, and an address field 346 are included in it.

The option type field 342 is a field to indicate that this option is a reachable address option 340. The optional length field 344 is a field to indicate the length of the reachable address option 340. The optional length field 344 may be used to indicate number of addresses included in the address field 346.

In the address field 346, an address owned by an address owner (i.e. a transmitter of the BA message), who has recognized the binding with the home address and the care-of address of the mobile node by the receiving of the BU message, is included in the linked address list.

The address field 346 may include a plurality of addresses. The transmitter of the BA message has no need to put all of a plurality of addresses owned by itself in the address field 346 and may select only an address, which it wants to notify to MN 50, and may put it in the address field 346.

When the format 300 of the BA message as shown in FIG. 3 is taken into account, the address 134 is included in the source address field 302, the care-of address of MN 50 is included in the destination address field 304, and the address 136 is included in the address field 346. Although the other field may be present in the format 300 of the BA message shown in FIG. 3, these other fields are not shown and described here. As the fields, which may be present in the BA message, there are a normal IPv6 header field such as a routing header field, a flow label, an encryption header field, and others.

Here, description has been given on a case where the linked address list is put in the mobility header 320 of the BA message, while a part or the entire linked address list may be transmitted by other arbitrary field or in an arbitrary message (any arbitrary message other than the BA message).

FIG. 4 shows a preferred functional architecture 400 of MN 50. MN 50 shown in FIG. 4 comprises one or more network interfaces 410 for transmitting and receiving a packet, a routing deciding unit 420 for deciding a route or a transfer method of the packet, a routing table 425 for holding information relating to a route of the packet and a method to transfer the packet, a mobility management module 430 for fulfilling mobility management functions such as the Mobile IPv6, and one or more upper layers 440, being disposed at upper position of a routing layer and including all protocols and programs.

The network interface 410 is a functional block to the entire hardware and software necessary for performing communication with other node via any arbitrary communication medium. When the terms known in the related technical field are used, the network interface 410 represents communication components of a layer 1 (a physical layer) and a layer 2 (a datalink layers, and firmware, driver, and communication protocol. The functional architecture 400 may have one or more network interfaces 410.

The routing deciding unit 420 has the functions to fulfill all decision-making processing relating to packet forwarding method. When the terms known in the related technical field is used, the routing deciding unit 420 comprises a layer 3 (a network layer) protocol such as IPv4, IPv6, etc.

In the routing table 425, the types of information to support the decision-making processing (rules for management of routing of the packet) in the routing deciding unit 420 are included. A list of routing entry is included in the routing table 425. In each routing entry, there are included a destination address or a source address, the network interface 410, to which the packet is to be delivered, and/or an address of the next hop node.

The routing deciding unit 420 can update the routing entry of the routing table 425 via a signal/data path 452 or to extract the routing entry from the routing table 425. Also, the routing deciding unit 420 can transmit or receive the packet at an adequate network interface 410 via the signal/data path 450.

The mobility management module 430 has the Mobile IPv6 function to perform operation as a mobile node. This Mobile IPv6 functions include the functions to execute various types of processing relating to mobility such as transmission of a binding update message to a home agent and/or to a correspondent node, management of care-of address and home address (management of binding information), transfer of the packet to be transmitted to a home agent by using home address, receiving of a tunnel packet from home agent, etc.

The mobility management module 430 has a binding update list (BUL) 435 and can record all nodes, to which mapping between the home address and the care-of address of the mobile node has been notified (i.e. the nodes where binding information of this mobile node is registered).

The mobility management module 430 also has a linked address list 433 as a new information storage unit and can store all addresses usable in communication. As a result, when MN 50 transmits a binding update message to a certain address, it is known that the owner of this address has already recognized the binding of MN 50, and there is no need to transmit the binding update message regarding to each address to the owner.

When the BA message with the reachable address option is received, MN 50 must update the linked address list 433 based on information included in the reachable address option.

Also, the packet can be received or delivered between the routing deciding unit 420 and the mobility management module 430 via a signal path 453. The mobility management module 430 can update or retrieve routing information stored in the routing table 425 via a signal path 456.

For instance, when the mobility management module 430 transmits a binding update message to a correspondent node or to a home agent, a route must be put in the routing table 425. As a result, the packet to be continuously transmitted to the correspondent node or the home agent is sent to the source address via a tunnel interface by using the care-of address of the mobile node.

The upper layer 440 represents all protocols and programs, which are present at an upper layer of a routing layer of communication protocol stack. In the upper layer 440, there are included a transport layer or a session layer such as a transmission control protocol (TCP), a stream control transmission protocol (SCTP), a user datagram protocol (UDP), etc. or applications and various types of functions necessary for performing communication with other nodes.

When the mobile node executes a method of site multi-homing, a host identity protocol (HIP) or a related communication protocol such as Shim6 are included in the upper layer 440. The packet can be received or delivered between the routing deciding unit 420 and the upper layer 440 via a signal path 454.

The mobility management module 430 provides a service access point (SAP) 460 so that direct access can be made from the upper layer 440 to the linked address list 433. This SAP 460 is so arranged that the upper layer 440 can notify a communicable address to the mobility management module 430.

For instance, according to the protocol such as Shim6 or SCTP, usable address can be exchanged between two communication endpoints. In this case, if an address is present, which is owned by the same endpoint in the upper layer 440, information of such address is recorded in the linked address list 433 via the SAP 460 from the upper layer 440. Based on the information in the linked address list 433, the mobility management layer can eliminate redundant signaling in the route optimization procedure.

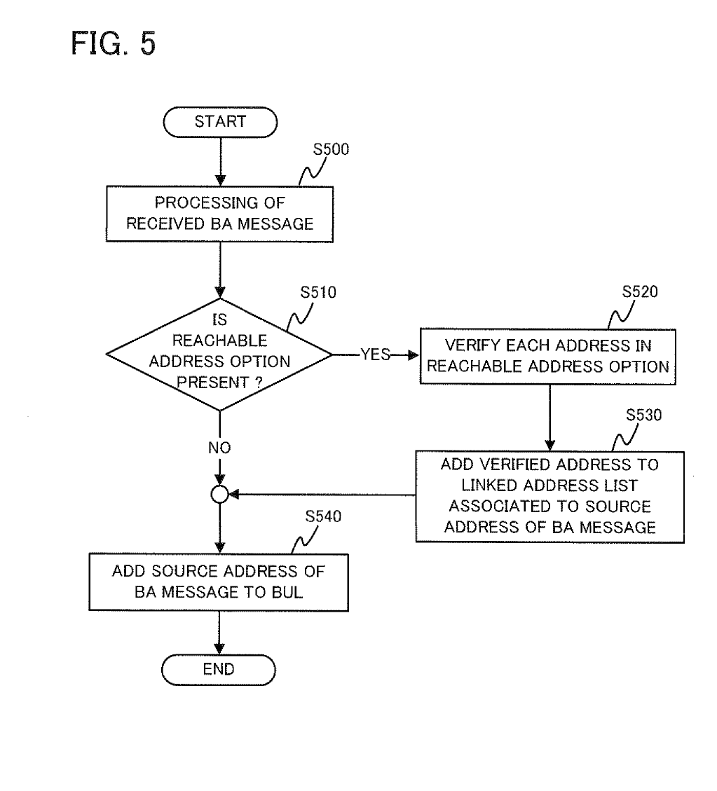

FIG. 5 shows an example of algorithm to be used by MN 50 when the received BA message is processed. In Step S500, normal processing on the received BA message is carried out. In the processing of the BA message at Step S500, validity of the BA message is checked or status of the binding is recorded. When it is confirmed that the BA message is valid, it is checked at Step S510 whether the reachable address option is included in this BA message or not.

When it is confirmed in Step S510 that the reachable address option is not present, the source address of the BA message is added in the binding update list 435 in Step S540. In this case, a specific flag, status, or lifetime of the BA message, etc. may be recorded at the same time.

On the other hand, when it is confirmed in Step S510 that the reachable address option is present, each of the addresses listed in the reachable address option is verified.

When the mobile node trusts in each of the addresses given in the reachable address option as it is, the verification processing may be the processing as simple as the verification as to whether the address is a valid global address or not. On the other hand, if the mobile node performs detailed verification on each of the addresses, verification processing may be carried out so that each of the addresses is transmitted to the ICMP echo request message and verification may be made by waiting for an adequate ICMP echo reply message.

After the address is verified, the mobile node adds each of the verified addresses to the linked address list 433 in Step S530, and the source address of the received BA message is associated with each address and is stored. Also, in Step S540, the source address of the BA message is added to the binding update list 435.

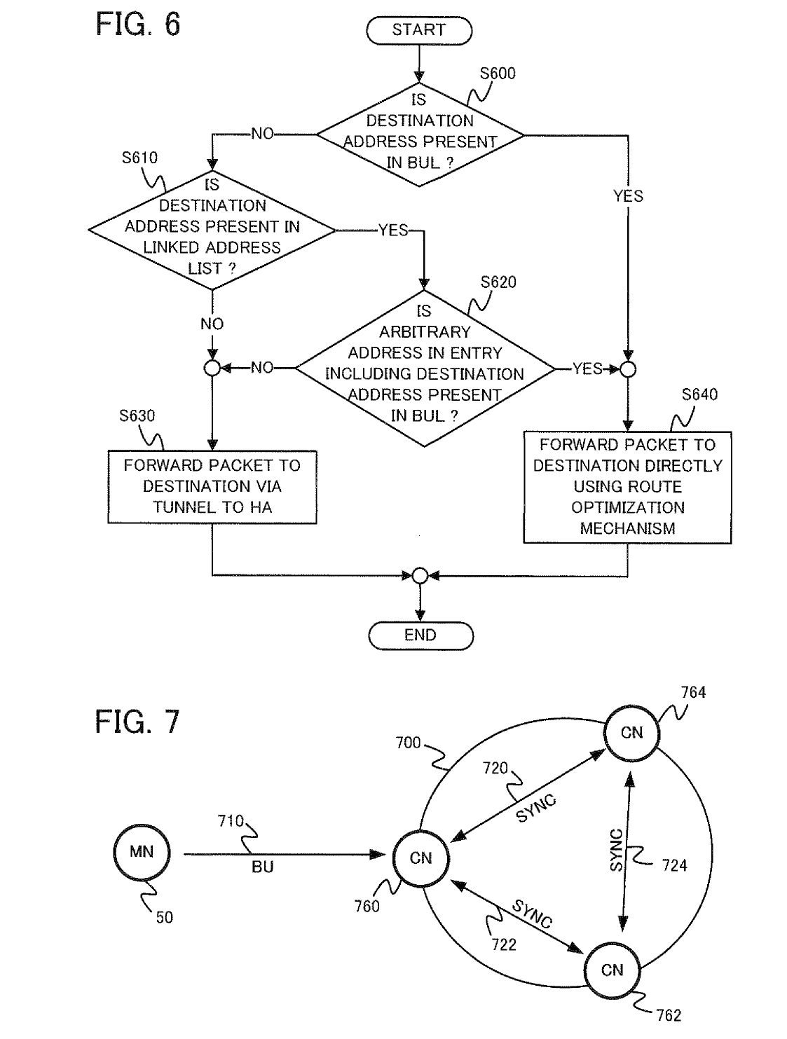

FIG. 6 shows an example of an algorithm to be used by MN 50 when the packet forwarding method is decided according to the destination address. When the packet is forwarded, the destination address to be set on the packet is acquired first, and it is checked in Step S600 whether the destination address is given in the binding update list 435 or not.

When it is confirmed in Step S600 that the destination address is listed in the binding update list 435, the packet is directly forwarded in Step S640 to the destination address via the route optimization mechanism. In this case, care-of address of the mobile node itself is used as the source address of the packet, and it is preferable that home address destination option is put in the header of the packet.

On the other hand, if it is not confirmed in Step S600 that the destination address is listed in the binding update list 435, it should be checked in Step S610 as to whether the destination address of the packet is listed in the linked address list 433.

If it is confirmed in Step S610 that the destination address is not listed in the linked address list 433, the packet is transferred to the destination via tunnel to the home agent in Step S630. That is, route optimization to the destination address is not carried out in this case.

On the other hand, if it is confirmed in Step S610 that the destination address is listed in the linked address list 433, entry of the linked address list 433 including the destination address is checked in Step S620, and it is checked as to whether any arbitrary address present in this entry is listed in the binding update list 435 or not.

When it is confirmed in Step S620 that an arbitrary address in the entry is listed in the binding update list 435, it is known to the owner of the destination address of the packet that binding information of the mobile node itself is already registered. Therefore, in Step S640, the packet is directly sent to the destination address via the route optimization mechanism.

On the other hand, when it is confirmed in Step S620 that an arbitrary address in the entry is not listed in the binding update list 435, the packet is transferred via tunnel of the home agent in Step S630.

In the embodiment of the invention as described above, description has been given on an example where the mobile node 50 performs communication with a correspondent node, which has a plurality of addresses (e.g. the address 134 and the address 136), while the invention can also be applied in a case where the mobile node 50 performs communication with a group of correspondent nodes (i.e. a plurality of correspondent nodes), each having only one address respectively. Referring to FIG. 7, description will be given on such case.

In FIG. 7, a group 700 of nodes (CN 760, CN 762 and CN 764) has a certain close relation with each other based on the group 700 in advance. As a result, synchronization (SYNC) messages 720, 722 and 724 are transmitted and received between these nodes, and common information (types of information used in common) is synchronized.

One of the types of common information in the group 700 can be binding update information received by any of the nodes of the group. In this case, when MN 50 transmits a BU message (BU) 710 to CN 760, for instance, binding update information is registered at CN 760. Also, in the other nodes (i.e. CN 762 and CN 764) synchronized with CN 760, the binding update information included in the binding update message is notified as the result of synchronization processing.

Accordingly, when MN 50 performs communication with CN 762 or CN 764, CN 762 or CN 764 is turned to a state where the binding information between the care-of address and the home address of MN 50 has already been recognized. Therefore, MN 50 can forward the packet via the route optimization mechanism without starting the route optimization procedure with CN 762 or CN 764.

As described above, when the group 700 of the nodes is already formed, any arbitrary node (e.g. CN 760) belonging to this group can notify to MN 50 that the addresses of the other nodes (CN 762 and CN 764) are related to the address of its own.

When the technique according to the present invention where there are a plurality of correspondent nodes as given above is compared with the prior art as disclosed in the Patent Document 1, for instance, the advantages of the technique of the present invention will be evident.

According to the prior art as disclosed in the Patent Document 1, the mobile node transmits a single binding update message to a first node (HA). In the binding update message, an address of a node, to which the binding update information is to be notified from the first node, is specified.

On the other hand, according to the present invention, the mobile node has no need to recognize or to know in advance that the binding message (i.e. notification of binding update information) is transmitted to the other node, and the first node autonomously distributes the binding information to the other node.

Also, the present invention can be applied to a case when the group of nodes must synchronize common information without regard to the transmission of the binding update message from the mobile node. As a preferred example of the group of this type, there is an overlay network of home agent disposed on a local or a global Internet network for the purpose of providing route optimization service or home agent reliability service.

In the description as given above, CN notifies the linked address list in the BA message. When this notification is given from MN to all of the BU messages received from MN, a BA message including non-understandable option field may be received at an MN where the present invention is not applied. As a result, various types of resources relating to the communication may be consumed such as processing of CN, communication range, processing of MN (including the case where the optional processing is skipped over by identifying that it is unnecessary option). By giving due consideration on this point, it may be so arranged that MN may give notification that the linked address list can be understood by additional option of the BU messages (or notification that the linked address list is requested), and the linked address list is notified only in the BA message to reply to the BU message of MN.

When a CoT message or a HoT message is used as the message to notify the linked address list, the linked address list can be notified to MN in earlier stage. In this case, also, the message to request the linked address list from MN can be included in a CoTI message or a HoTI message. Further, the address can be verified by using the BU message and the BA message. This is particularly effective in case CN uses two addresses. By transmitting a BU message to an address different from the address, on which return routability test has been carried out (i.e. the address, which is newly notified as the linked address list) and by receiving a BA message, which is the reply, the verification of the address will be completed. This is because the result that even key information given and taken over an interface (address) can also be understood (is receivable) when it is transmitted to the other interface (address).

In the present specification, description has been given on a case where, after MN has completed the route optimization with a node having one of the address, MN performs the route optimization with a node having the other address. Actually, however, MN does not recognize or comprehend that these addresses are the addresses of the same node, and the route optimization procedure may be started to these addresses at the same time (or the other route optimization procedure may be started before the completion of the first route optimization procedure). In this case, redundant signaling may occur in the first route optimization procedure, but MN comprehends that these addresses are owned by the same node when the linked address list is received. Therefore, in the subsequent BU, such as the BU to be executed in association with the moving of MN or the BU executed in association with time-out of the exchanged key information, a single transmission of the BU message would suffice by the operation as given above of the present invention, and redundant signaling can be reduced.

When CN receives a CoTI message or a HoTI message for the route optimization procedure at the same time (or the other route optimization procedure before the completion of the first route optimization procedure) from the same MN (source address), it may be so designed that only a CoT message or a HoT message to the CoTI message or the HoTI message is sent as a reply together with the linked address list for the purpose of preventing generation of redundant signaling. Specifically, at the moment when CN having a plurality of addresses detects the route optimization procedure with each of the addresses at the same time by the same MN, it may be notified that these addresses are owned by the same CN. In this case, the above procedure may be preferably performed only when it is confirmed by CN that the linked address list is requested from MN, for instance, and MN can comprehend the linked address list.

In the present specification, drawings and descriptions have been given with due consideration that the invention will provide the most practical and the most preferred embodiment, while it would be obvious to those skilled in the art that various changes and modifications can be made without departing from the spirit and the scope of the invention in the details of designing and parameters relating to various types of component elements. For instance, the present invention can be applied to any arbitrary node (e.g. a home agent or the other mobile node), which performs communication with a mobile node. Further, the present invention can also be applied to both a mobile host in operating the Mobile IPv6 and a mobile router, which operates network mobility support.

Each functional block used in the description of the embodiments of the present invention as given above can be realized as LSI (Large Scale Integration), typically represented by the integrated circuit These may be produced as one chip individually or may be designed as one chip to include a part or all. Here, it is referred as LSI, while it may be called IC, system LSI, super LSI, or ultra LSI, depending on the degree of integration.

Also, the technique of integrated circuit is not limited only to LSI and it may be realized as a dedicated circuit or a general-purpose processor. FPGA (Field Programmable Gate Array), which can be programmed after the manufacture of LSI, or a reconfigurable processor, in which connection or setting of circuit cell inside LSI can be reconfigured, may be used.

Further, with the progress of semiconductor technique or other techniques derived from it, when the technique of circuit integration to replace LSI may emerge, the functional blocks may be integrated by using such technique. For example, the adaptation of biotechnology is one of such possibilities.

### INDUSTRIAL APPLICABILITY

According to the present invention, a mobile node detects generation of redundant route optimization message to an address owned by a node, which already recognizes the binding of a care-of address and a home address of the mobile node, and the effects to reduce excessive message exchange can be provided. The invention can be applied to the technical field relating to packet communication in IP network. In particular, the invention can be applied to the technical field relating to route optimization in the mobility management protocol such as the Mobile IPv6 or to the technical field relating to multi-interface for the management of a plurality of addresses.

1. A packet communication device, comprising:
packet communication means for performing communication via a network,
binding update processing means for carrying out return routability procedure and binding update processing to execute route optimization with a specific address;
link address acquiring means for acquiring another address usable by a communication device using said specific address;
link address storage means for associating said specific address with said another address of said communication device acquired by said link address acquiring means and storing said addresses;
link address confirming means for confirming whether or not said new address concurs with said another address of said communication device based on information stored in said link address storage means, when performing route optimization with a new address; and
route optimization communication control means for controlling starting of route optimized communication with said new address without carrying out said return routability procedure and said binding update processing relating to said new address when it is confirmed that said new address concurs with said another address of said communication device.

2. The packet communication device according to claim 1, wherein said link address acquiring means acquires a list of said other addresses usable by said communication device from a message received from said communication device.

3. The packet communication device according to claim 2, wherein said message is a binding acknowledgment message, which is a reply to a binding update message related to said specific address.

4. The packet communication device according to claim 2, wherein said message is a HoT message or a CoT message of said return routability procedure to be executed for performing route optimized communication with said specific address.

5. The packet communication device according to claim 4, wherein said binding update processing means is so designed that a binding update message relating to said specific address is transmitted to said another address of said communication device as acquired by said link address acquiring means.

6. The packet communication device according to claim 1, wherein there is provided address verifying means for verifying whether said another address of said communication device acquired by said link address acquiring means is a valid address or not.

7. The packet communication device according to claim 6, wherein said address verifying means transmits a message for verification to said another address and confirms whether said another address is a valid address or not based on a reply message.

8. The packet communication device according to claim 1, wherein said link address storage means is placed under management at a layer for routing processing of the packet, said link address acquiring means belongs to an upper layer higher than a layer where routing processing of said packet is performed, and said link address acquiring means is provided with a layer-to-layer interface capable to directly carry out writing of information to said link address storage means.

9. The packet communication device according to claim 1, wherein it is so designed that said link address acquiring means requests notification of another address usable by said communication device to said communication device.

10. A packet communication device, comprising:
packet communication means for performing communication via a network;
a plurality of addresses managing means for managing a plurality of addresses to be used on communication in said packet communication means; and
address notifying means for notifying a plurality of addresses under management of said plurality of addresses managing means by using a message to be sent to said mobile node in return routability procedure and binding update processing to be executed for performing route optimized communication with a mobile node.

11. The packet communication device according to claim 10, wherein, when a binding update message for performing route optimization with one of a plurality of addresses under management of said plurality of addresses managing means is received from said mobile node, an address list where at least the remaining addresses other than said one address from said plurality of addresses are listed is put in a binding acknowledgment message as a reply to said binding update message.

12. The packet communication device according to claim 10, wherein, when a CoTI message or a HoTI message for performing route optimization with one of a plurality of addresses under management of said plurality of addresses managing means is received from said mobile node, an address list where at least the remaining addresses other than said one address from said plurality of addresses are listed is sent back by putting in a CoT message, which is a reply to said CoTI message, or in a HoT message, which is a reply to said HoTI message.

13. The packet communication device according to claim 10, wherein, when a notification request of a plurality of addresses under management of said plurality of addresses managing means, said address notifying means notifies a plurality of addresses under management by said plurality of addresses managing means.
